(19) United States
(12) Patent Application Publication
(10) Pub. No.: US 2015/0177877 A1
(43) Pub. Date: Jun. 25, 2015

(54) TOUCH SENSITIVE SWITCHING DEVICE

(71) Applicant: DENSO CORPORATION, Kariya-city, Aichi-pref. (JP)

(72) Inventor: Shinsuke Hisatsugu, Kariya-city (JP)

(21) Appl. No.: 14/414,021

(22) PCT Filed: Jul. 10, 2013
(86) PCT No.: PCT/JP2013/004256

§ 371 Date: Jan. 9, 2015

(30) Foreign Application Priority Data
Jul. 13, 2012 (JP) 2012-157874

(51) Int. Cl. G06F 3/044; G06F 3/041

(52) U.S. Cl. CPC G06F 3/044; G06F 3/0416

(57) ABSTRACT

A touch sensitive switching device includes: a touch plate having multiple switching operation units on a surface thereof; a film sensor having an electrode arranged on a side of the touch plate opposite to a corresponding switching operation unit and opposed to the corresponding switching operation unit, a touch-operation to one switching operation unit being detected by a potential change of a corresponding electrode; and an adjustment plate arranged between the touch plate and the film sensor and made of material having a dielectric constant different from a dielectric constant of the touch plate. A part of the adjustment plate at a position corresponding to each of the switching operation units has a different thickness.

### CROSS REFERENCE TO RELATED APPLICATION

This application is based on Japanese Patent Application No. 2012-157874 filed on Jul. 13, 2012, the disclosure of which is incorporated herein by reference.

### TECHNICAL FIELD

The present disclosure relates to a touch sensitive switching device for controlling a switch to turn on and off by operating a touch plate.

### BACKGROUND ART

A touch sensitive switching device described in Patent Literatures No. 1 and No. 2 has a structure such that a touch plate and a film sensor are stacked (please refer to Patent Literatures No. 1 and No. 2). Multiple switching operation units, which are operated by contacting with a finger or the like of an operator, are formed on a surface of the touch plate. The film sensor is arranged on a backside of the touch plate. The film sensor includes electrodes, which are arranged to face a respective switching operation unit. When the finger contacts the switching operation unit, an electrostatic capacitance on the electrode is changed, so that the device detects a contact operation based on the change of the electrostatic capacitance.

Here, a position of the switching operation unit in depth is varied according to a convexity and a concavity on a designing surface (i.e., the surface) of the touch plate. Thus, a dimension in a thickness of the touch plate is also varied according to the convexity and the concavity on the designing surface. As a result, the electrostatic capacitance on the electrode at a portion having a small dimension in the thickness is smaller than the electrostatic capacitance on the electrode at a portion having a large dimension in the thickness. Accordingly, the operation sensitivity when operating and touching the switching operation unit having the small electrostatic capacitance is higher than the switching operation unit having the large electrostatic capacitance.

Further, the operation sensitivity is varied according to the difference of the area of the electrode. Accordingly, when the operation sensitivity of multiple switching operation units is equalized, it is necessary to adjust and change the dimension of the touch plate in the thickness according to the difference of the area of the electrode. However, when the dimension of the touch plate in the thickness is adjusted, it is impossible to form the shape of the designing surface of the touch plate to be a required shape. Specifically, when the dimension of the touch plate in the thickness is determined in view of the adjustment of the operation sensitivity, the designing degree of freedom in the shape of the designing surface is reduced. On the other hand, when the dimension of the touch plate in the thickness is determined in view of the shape of the designing surface, it is difficult to set the operation sensitivity to be a required sensitivity.

### PRIOR ART LITERATURES

### Patent Literature

Patent Literature 1: JP-A-2010-86385

Patent Literature 2: JP-A-S61-64031

### SUMMARY OF INVENTION

It is an object of the present disclosure to provide a touch sensitive switching device, a designing degree of freedom of which is improved when a design of a designing surface or a design of an operation sensitivity of the touch plate is performed.

According to a first aspect of the present disclosure, a touch sensitive switching device includes: a touch plate (10) having a plurality of switching operation units (11-17) on a surface of the touch plate, each switching operation unit being touch-operated; a film sensor (20) having a plurality of electrodes (21-27), each of which is arranged on a backside of the touch plate opposite to a corresponding switching operation unit, and is opposed to the corresponding switching operation unit, a touch-operation to one switching operation unit being detected by a potential change of a corresponding electrode; and an adjustment plate (30) arranged between the touch plate and the film sensor and made of material having a dielectric constant different from a dielectric constant of the touch plate. A part of the adjustment plate at a position corresponding to each of the plurality of switching operation units has a different thickness.

In the above touch sensitive switching device, the thickness of the adjustment plate is adjusted according to a position of the backside of the switching operation unit, so that the electrostatic capacitance of each switching operation unit is adjusted, and the operation sensitivity is controlled. Specifically, as a result of the above adjustment, the thickness of the adjustment plate is set to have a different dimension according to a position of the backside of the switching operation unit. Further, when the thickness of the touch plate is adjusted based on the thickness of the adjustment plate, the electrostatic capacitance is adjusted, and the sensitivity is controlled to be a required sensitivity with designing the shape (i.e., a designing surface shape) of the front side of the touch plate to be a required shape. Thus, when the design of the designing surface shape of the touch plate or the design of the operation sensitivity is performed, the thickness of the adjustment plate and the thickness of the touch plate are adjusted so that the design degree of freedom is improved.

### BRIEF DESCRIPTION OF DRAWINGS

The above and other objects, features and advantages of the present disclosure will become more apparent from the following detailed description made with reference to the accompanying drawings. In the drawings:

FIG. 1 is a front diagram of a touch sensitive switching device according to a first embodiment;

FIG. 2 is a cross sectional diagram taken along line II-II in FIG. 1;

FIG. 3 is a cross sectional diagram taken along line II-II in FIG. 1;

FIG. 4 is a front diagram of a film sensor shown in FIG. 2;

FIG. 5 is a cross sectional diagram according to a second embodiment;

FIG. 6 is a cross sectional diagram according to a third embodiment;

FIG. 7 is a cross sectional diagram showing a structure of a touch sensitive switching device, which has been studies as a comparison device by the inventors.

### EMBODIMENTS FOR CARRYING OUT INVENTION

Each embodiment of a touch sensitive switching device according to the present disclosure will be explained with reference to the drawings. Here, in each embodiment, constitutions of parts having the same reference number in the drawings are the same or equivalent to each other, and the explanation will be incorporated.

### First Embodiment

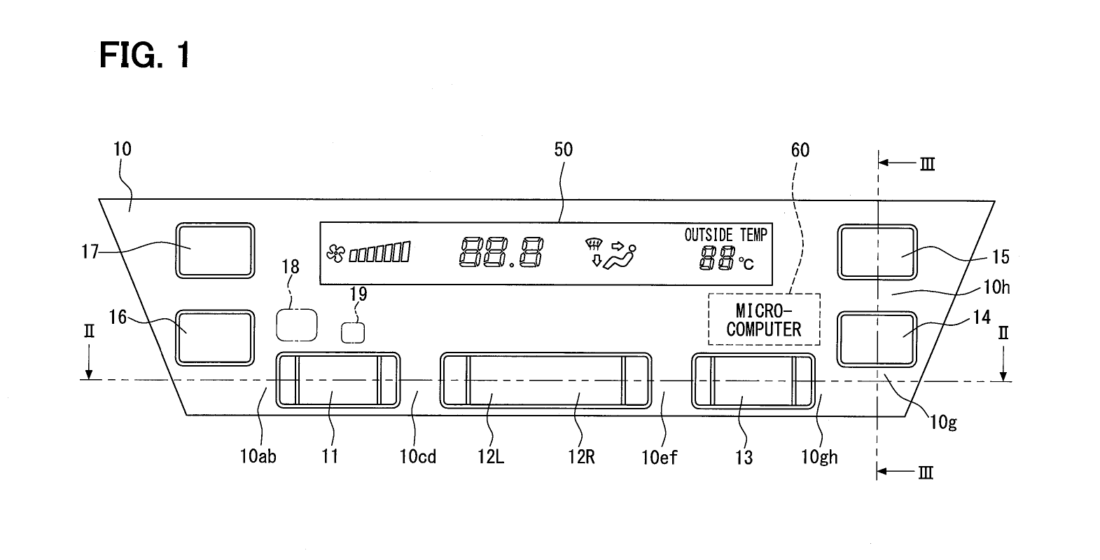

The touch sensitive switching device shown in FIG. 1 is mounted on a vehicle. Specifically, the device is attached to an instrumental panel in a compartment of the vehicle. The touch sensitive switching device includes a touch plate 10 made of resin. The touch plate 10 provides a designing surface, which is exposed in the compartment. The touch plate 10 includes multiple switching operation units 11, 12L, 12R, 13, 14, 15, 16, 17, which are operated and touched by a finger of an operator. For example, when the operator touches the switching operation unit 11 with the finger, an air conditioning device is activated. An operation condition of the air conditioning device is displayed on a liquid crystal display unit 50.

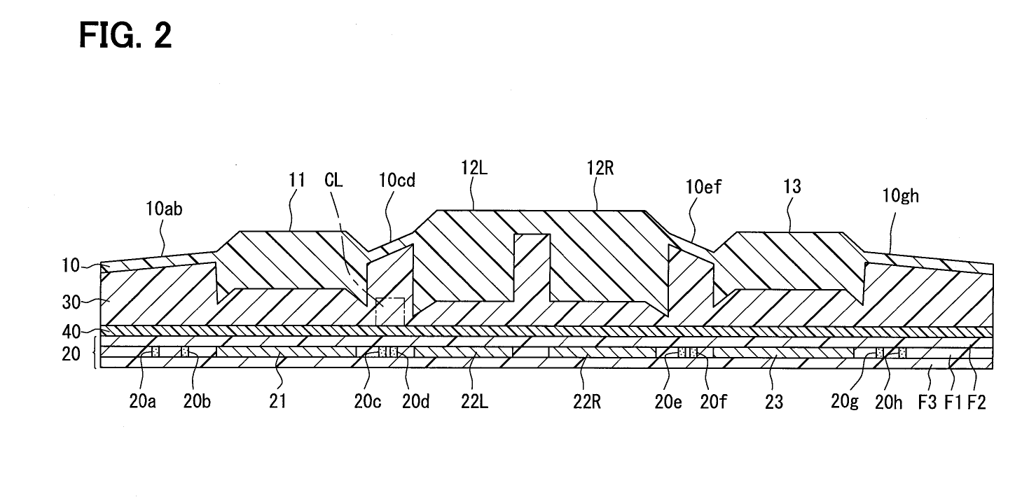

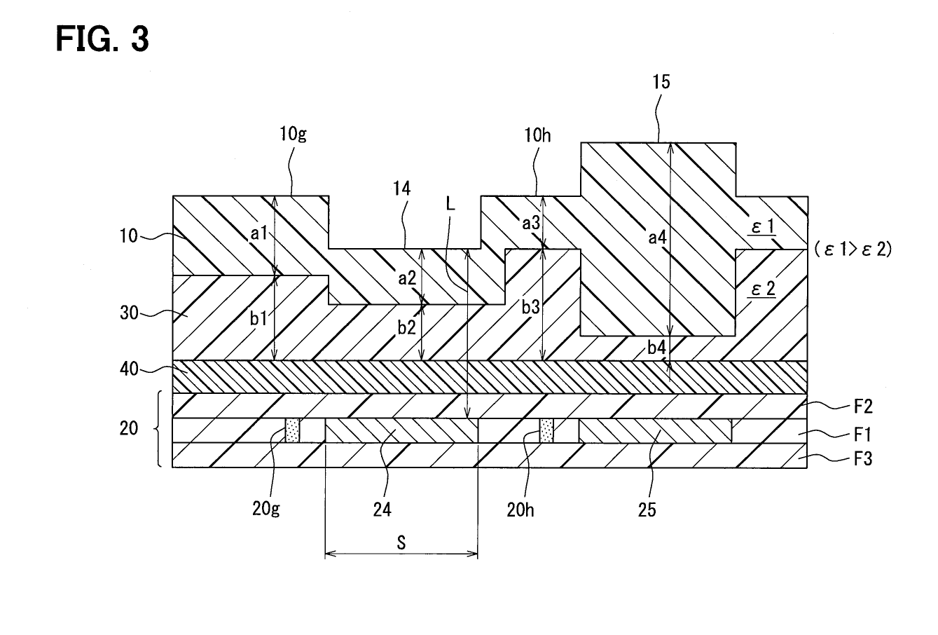

As shown in FIGS. 2 and 3, the touch sensitive switching device includes a film sensor 20. The film sensor 20 is arranged on the backside of the touch plate 10 seeing from the operator. The sensor 20 has a structure such that three layer films F1, F2, F3 are stacked. An adjustment plate 30 is arranged between the touch plate 10 and the film sensor 20. The film sensor 20 is bonded to the adjustment plate 30 via an adhesive 40 such as a double stick tape.

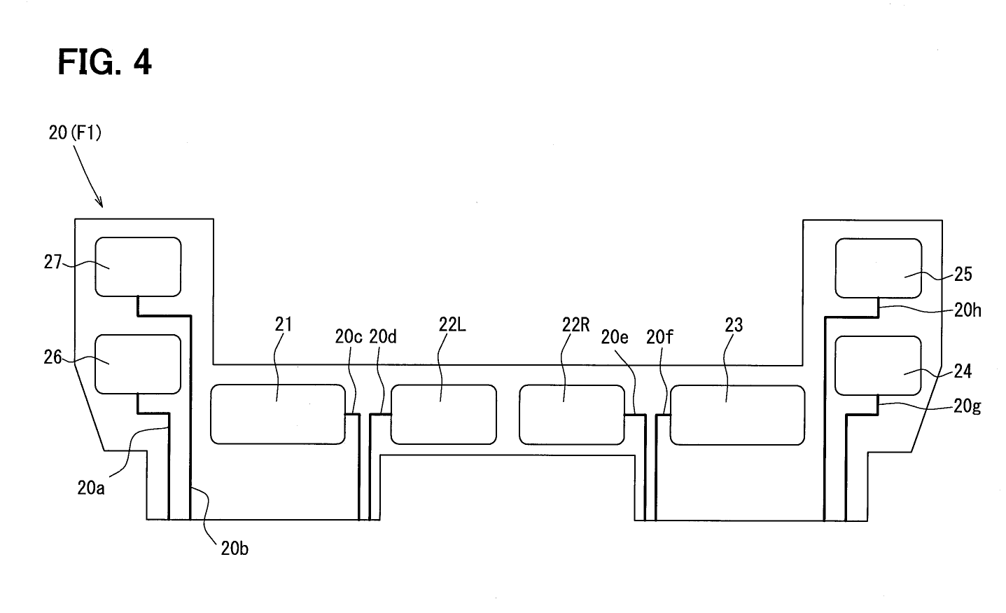

FIG. 4 is a front diagram of the film F1 for providing the film sensor 20. The film F1 includes electrodes 21, 22L, 22R, 23, 24, 25, 26, 27 at positions facing the switching operation units 11-17, respectively, and wirings 20a, 20b, 20c, 20d, 20e, 20f, 20g, 20h connecting to the electrodes 21-27, respectively. The films F1 to F3 are made of a resin film having electric insulation. The film sensor 20 is formed such that the films F2, F3 sandwich the backside and the front side of the film F1 having the electrodes 21-27 and the wirings 20a-20h.

Here, the wirings 20a-20h are connected to a microcomputer (i.e., MICROCOMPUTER 60) shown in FIG. 1. Detection signals output from the electrodes 21-27 are input into the microcomputer 60 via the wirings 20a-20h.

The touch plate 10 and the adjustment plate 30 are made of resin and have a plate shape. However, the plates 10, 30 are made of resin having material with different dielectric constant. An example of resin is acrylic, polycarbonate, nylon (registered trademark), ABS or the like. In the present embodiment, the material is selected so that the dielectric constant of the touch plate 10 is higher than the dielectric constant of the adjustment plate 30.

The touch plate 10 and the adjustment plate 30 may be integrally formed by resin in such a manner that the resin material of the touch plate 10 and the resin material of the adjustment plate 30 are double molded. Alternatively, the touch plate 10 and the adjustment plate 30 are independently resin molded, and then, the plates 10, 30 are bonded to each other with adhesive.

When a finger is put on the switching operation unit 11-17, the electrostatic capacitance between the finger and the electrode 21-27 is changed, so that a potential of the electrode 21-27 is varied. A signal indicative of the potential change corresponds to a detection signal described previously. The microcomputer 60 (as a detection device) determines whether the potential of the detection signal is equal to or larger than a threshold so that the microcomputer 60 detects whether the operation of the switching operation unit 11-17 is performed. The threshold used in the determination is set to be a common value with respect to all electrodes 21-27.

Here, under a condition that the finger is not put on the switching operation unit 11-17, the electrostatic capacitance C of the electrode 21-27 is presented by the following equation.

C=ε1·ε2·S/L

Here, ε1 in the equation represents a dielectric constant of the touch plate 10, and ε2 in the equation represents a dielectric constant of the adjustment plate 30. As describe above, a relationship of ε>ε2 is satisfied. Further, S represents an area of the electrode 21-27, and L represents a distance from the electrode 21-27 to the switching operation unit 11-17 (please refer to FIG. 3). L represents a sum of the thickness of both plates 10, 30, the adhesive 40 and the film F2. The thickness of the adhesive 40 and the thickness of the film F2 are negligibly small. Thus, L mainly represents the thickness of both plates 10, 30.

Accordingly, a ratio between the thickness of the touch plate 10 shown as references of a1, a2, a3 and a4 in FIG. 3 and the thickness of the adjustment plate 30 shown as references of b1, b2, b3 and b4 is adjusted, so that the electrostatic capacitance C is changeable without changing the distance L. For example, under a condition that the distance L is constant, when the thickness of the adjustment plate 30 becomes thicker, the thickness of the touch plate 10 having the large dielectric constant ε1 becomes thinner, and the electrostatic capacitance C becomes smaller. As a result, the detection signal (i.e., the potential) becomes equal to or larger than the threshold, so that the determination that the operation is performed is easily obtained. Specifically, when the switching operation unit 11-17 is operated, the operation sensitivity is increased.

Regarding an element such as the switching operation units 15, 12L, 12R having the distance L in design longer than other switching operation units, a ratio of the thickness a4 of the touch plate 10 with respect to the distance L is increased, and a ratio of the thickness b4 of the adjustment plate 30 with respect to the distance L is decreased. Thus, the electrostatic capacitance C of the switching operation unit 12, 12L, 12R having the long distance L is adjusted to be equal to the electrostatic capacitance C of the switching operation unit 11, 13, 14 having the short distance L. Thus, the operation sensitivities of units are adjusted to be same.

In short, the thickness of the touch plate 10 and the thickness of the adjustment plate 30 are set to be different dimensions according to the switching operation units 11-17 (i.e., an element on the touch plate 10), so that the electrostatic capacitance of each switching operation unit 11-17 is adjusted. Thus, the operation sensitivity is adjusted. The operation sensitivity of each switching operation unit 11-17 may be adjusted differently. Alternatively, the operation sensitivity of each switching operation unit 11-17 may be adjusted to be same.

Here, a part of the touch plate 10 other than the switching operation units 11-17 and facing the wirings 20a-20h is defined as a wiring facing part 10ab, 10cd, 10ef, 10gh, 10g, 10h. The thickness a1-a4 of the touch plate 10 and the thickness b1-b4 of the adjustment plate 30 are determined so that the electrostatic capacitance C of the wiring facing part 10ab-10h is larger than the electrostatic capacitance C of the switching operation unit 11-17. Specifically, the dimensions b1, b3 of the wiring facing parts 10g, 10h among the thickness b1-b4 of the adjustment plate 30 are set to be larger than the dimensions b2, b4 of the switching operation units 14, 15, respectively.

Thus, in the present embodiment, the thickness of the adjustment plate 30 and the thickness of the touch plate 10 are adjusted, so that the electrostatic capacitance of each switching operation unit 11-17 is adjusted with setting the shape of the surface (i.e., the designing surface) of the touch plate 10 to be a required shape. Thus, the operation sensitivity is adjusted to be required sensitivity. Accordingly, when the designing surface shape and the operation sensitivity of the touch plate 10 are determined, the designing degree of freedom is improved.

Further, according to the present embodiment, the following effects (a) and (b) are obtained.

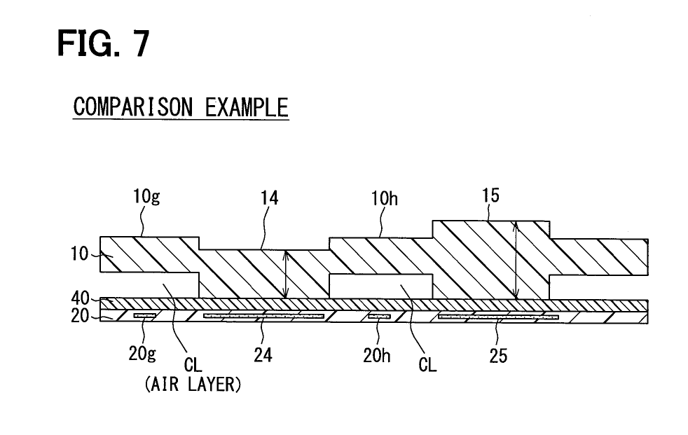

(a) Here, when the finger is put on the wiring facing part 10g, 10h, the detection signal output from the electrode 24-25 is changed, so that detection error may be concerned that the touch operation is performed. Thus, the present inventor has studied that, as shown in FIG. 7, an air layer CL is arranged between the touch plate 10 and the adhesive 40 on the backside of the wiring facing parts 10g, 10h. In this case, the change of the electrostatic capacitance caused in a case where the finger is put on the wiring facing part 10g, 10h is restricted. Thus, the detection error is prevented. However, in this construction, the bonding area between the touch plate 10 and the film sensor 20 is reduced by the air layer CL, so that the bonding force is reduced.

In view of the above point, in the present embodiment, the thickness a1-a4 of the touch plate 10 and the thickness b1-b4 of the adjustment plate 30 are determined so that the electrostatic capacitance C of the wiring facing part 10ab-10h is larger than the electrostatic capacitance C of the switching operation unit 11-17. Accordingly, the change of the electrostatic capacitance caused in a case where the finger is put on the wiring facing part 10g, 10h is restricted without arranging the air layer CL or with reducing the area of the air layer CL. Thus, the bonding force of the film sensor 20 with respect to the touch plate 10 and the adjustment plate 30 is sufficiently secured, and the detection error is prevented.

(b) The device includes the microcomputer 60 (as a determination device) for determining whether the potential of the electrode is equal to or larger than the threshold so that the microcomputer 60 determines whether the operation of the switching operation unit 11-17 is performed. The thickness of the adjustment plate 30 is set at each switching operation unit 11-17 so as to equalize the threshold for determining the existence or non-existence of the touch operation with respect to each electrode 21-27.

Here, the operation sensitivity is adjusted by adjusting the determination threshold. However, it is necessary to perform a step for adjusting the determination threshold so as to set the operation sensitivity of each switching operation unit 11-17 to be a required sensitivity. This step requires labor hour. In view of this point, in the present embodiment, the thickness of the adjustment plate 30 is adjusted so as to equalize the determination threshold at each switching operation unit 11-17 to be same. Thus, it is not necessary to perform the above step.

### Second Embodiment

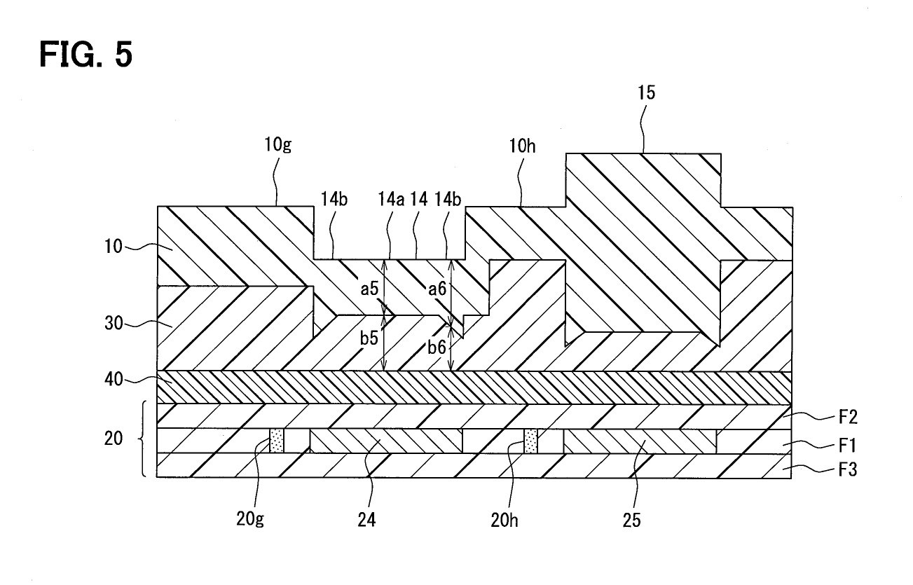

In the first embodiment, the thickness a2 of the touch plate 10 and the thickness b2 of the adjustment plate 30 are set to be equal to each other in a range of the same switching operation unit 14. On the other hand, in the present embodiment shown in FIG. 5, the thickness a5, a6 of the touch plate 10 and the thickness b5, b6 of the adjustment plate 30 are determined such that the electrostatic capacitance of a part disposed at the end portion 14b of the switching operation unit 14 is smaller than the electrostatic capacitance of a part disposed at a center portion 14a of the switching operation unit 14.

Specifically, the thickness a6 of the touch plate 10 corresponding to the end portion 14b is set to be larger than the thickness a5 of the touch plate 10 corresponding to the center portion 14a. Further, the thickness b6 of the adjustment plate 30 corresponding to the end portion 14b is set to be smaller than the thickness b5 of the adjustment plate 30 corresponding to the center portion 14a. Thus, the operation sensitivity of the end portion 14b is higher than the operation sensitivity of the center portion 14a.

Here, in some cases, it may be difficult to detect the operation when the operator puts the finger on the end portion 14b. Specifically, there is a concern that it is difficult for the switching operation unit 14 disposed on a left side of FIG. 5 to detect the operation at the end portion 14b since the surface of the touch plate 10 has a concavity.

In view of the above point, in the present embodiment, since the operation sensitivity of the end portion 14b is increased, the above concern is easily resolved. Specifically, since the sensitivity of the end portion 14b of the switching operation unit 14 is increased, the reliability for detecting that the touch operation is performed is improved even when the finger is put on the end portion 14b.

### Third Embodiment

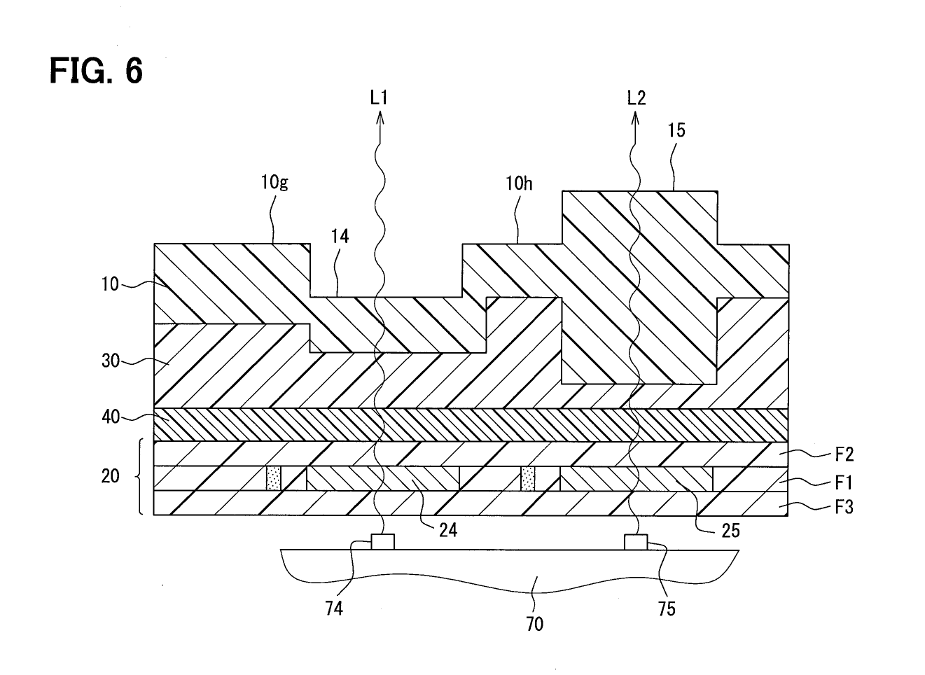

In the present embodiment shown in FIG. 6, the switching operation unit 14, 15 is transparently irradiated using a light source 74, 75 such as a LED and a valve. The light source 74, 75 is mounted on a substrate 70, which is arranged on the backside of the film sensor 20. The electrode 24, 25 is formed of an electrode having translucency. Further, the film F1, F2, F3, F4 and the adhesive 40 and the plates 10, 30 are also made of materials having the translucency. Thus, the light emitted from the light source 74, 75 transmits the film sensor 20, the adhesive 40 and the plates 10, 30 so that the switching operation unit 14, 15 is translucently irradiated (please refer to an arrow L1, L2).

Here, light shielding paint is applied to a portion of the backside of the adjustment plate 30 corresponding to a none translucent irradiation part so that a part (i.e., the none translucent irradiation part) of the touch plate 10 other than the switching operation units 14, 15 is not translucently irradiated.

Further, a part of the adjustment plate 30 corresponding to the none translucent irradiation parts including the wiring facing parts 10ab, 10cd, 10ef, 10gh, 10g, 10h is made of material having translucency lower than the touch plate 10 in order to improve the light shielding effect.

Specifically, in order to prevent a detection error of the switching operation unit 11-17, the thickness of the adjustment plate 30 corresponding to the none translucent irradiation parts is set to be large. Accordingly, the none translucent irradiation parts has the translucency lower than the switching operation unit 11-17. Thus, the light shielding effect at the none translucent irradiation parts is improved. Thus, in the present embodiment, the thickness of the touch plate 10 and the thickness of the adjustment plate 30 are adjusted so that the translucency is controlled. Thus, the visual quality of the touch plate 10 is controlled.

### Fourth Embodiment

In the present embodiment, the thickness of the touch plate 10 and the thickness of the adjustment plate 30 are adjusted such that, as the operation area of the switching operation unit among multiple switching operation units 11-17, 18, 19 becomes small, the electrostatic capacitance of a part disposed at the switching operation unit becomes small. Specifically, the electrostatic capacitance of the switching operation unit 18, 19 is set to be smaller than the switching operation unit 16.

Thus, the operation sensitivity of the switching operation unit 18, 19 having the small operation area is higher than the operation sensitivity of the switching operation unit 17 having the large operation area. Thus, when the operator puts the finger on the switching operation unit 18, 19 having the small operation area, the concern for not detecting the operation is reduced.

### Other Embodiments

The present disclosure is not limited to the contents described in the above embodiments, and the present disclosure may be modified by the following manners. Alternatively, the features in each embodiment may be combined appropriately.

In the above embodiments, the material is selected such that the dielectric constant of the touch plate 10 is higher than the dielectric constant of the adjustment plate 30. In the other way, the material may be selected such that the dielectric constant of the adjustment plate 30 is higher than the dielectric constant of the touch plate 10.

In the above embodiments, the threshold of the switching operation units 11-17 for determining whether the operation is performed are set to be a common value with respect to all electrodes 21-27. Alternatively, the threshold may be set to be different from each other at each switching operation unit 11-17.

In the above embodiments, the backside of the adjustment plate 30 has a flat shape, and the backside has no step. Specifically, the bonding surface between the film sensor 20 and the adjustment plate 30 using the adhesive 40 is flat. Alternatively, the backside of the adjustment plate 30 may have a step shape, and the bonding surface has a step.

In the above embodiments, the feature that the air layer is formed on the backside of the adjustment plate 30 is not adopted. Alternatively, the air layer may be formed on a part of the backside of the adjustment plate 30 shown as a chain line CL in FIG. 2 so that the part has a large electrostatic capacitance.

In the above embodiments, a user performs a touch operation of the switching operation unit 11-17 with a finger. Alternatively, the switching operation unit 11-17 of the touch sensitive switching device may be operated and touched by an operation body such as a touch pen.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A touch sensitive switching device comprising:
a touch plate having a plurality of switching operation units on a surface of the touch plate, each switching operation unit being touch-operated;
a film sensor having a plurality of electrodes, each of which is arranged on a backside of the touch plate opposite to a corresponding switching operation unit, and is opposed to the corresponding switching operation unit, a touch-operation to one switching operation unit being detected by a potential change of a corresponding electrode; and
an adjustment plate arranged between the touch plate and the film sensor and made of material having a dielectric constant different from a dielectric constant of the touch plate,
wherein a part of the adjustment plate at a position corresponding to each of the plurality of switching operation units has a different thickness.

2. The touch sensitive switching device according to claim 1,
wherein the film sensor includes a wiring connected to each electrode, and
wherein the thickness of the adjustment plate is set such that an electrostatic capacitance of the touch plate and the adjustment plate at a position opposed to the wiring is larger than an electrostatic capacitance of the touch plate and the adjustment plate at a position opposed to the electrode.

3. The touch sensitive switching device according to claim 1, further comprising:
a determination device detecting whether a potential of the electrode is equal to or larger than a threshold so that the determination device determines whether an operation to the switching operation unit is performed,
wherein the thickness of the adjustment plate is set at each switching operation unit so as to equalize the threshold of each electrode.

4. The touch sensitive switching device according to claim 1,
wherein the thickness of the adjustment plate is set such that an electrostatic capacitance of the touch plate and the adjustment plate at a position opposed to an end portion of the switching operation unit is smaller than an electrostatic capacitance of the touch plate and the adjustment plate at a position opposed to a center portion of the switching operation unit.

5. The touch sensitive switching device according to claim 1,
wherein the thickness of the adjustment plate is set such that an electrostatic capacitance of the touch plate and the adjustment plate becomes small as an operation area of the switching operation unit becomes small.
